(19) United States
(12) Patent Application Publication
(10) Pub. No.: US 2004/0227054 A1
(43) Pub. Date: Nov. 18, 2004

(54) Mould for patterning foods to bear distinct color-blocks

(76) Inventor: Yu Chin Teh, Taipei (TW)

Correspondence Address: BIRCH STEWART KOLASCH & BIRCH, PO BOX 747, FALLS CHURCH, VA, 22040-0747, US

(21) Appl. No.: 10/437,235

(22) Filed: May 14, 2003

(51) Int. Cl. B29C 33/42

(52) U.S. Cl. 249/160

(57) ABSTRACT

A mould for patterning foods to bear distinct color-blocks has at least a retaining wall arranged in a mould cavity thereof for partitioning the cavity into separate divisions for receiving different color-blocks. In practice, the mould cavity is, in full conformity with a pattern food to be formed, formed in a central portion of the mould body. When processing, a liquid food in different colors is first poured into the retaining walls, then another liquid food is in turn poured accordingly for forming a pattern food with distinct color blocks. By doing so, distinct color blocks of a pattern food could be obtained without color migration.

### FIELD OF THE INVENTION

This invention relates generally to a mould for patterning foods, particularly to a mould employed to pattern and make foods bear distinct color-blocks by way of setting a separate wall therein.

### BACKGROUND OF THE INVENTION

The patterned foods available in market, chocolate or candy sticks for example, are usually divided into a monochromatic or a multicolored pattern, in which the color of the boundary of every two neighboring color blocks of the multicolored pattern is liable to be mingled with different colors to deteriorate the integral vision impression thereof, which is especially observable in the case of smaller color blocks.

The conventional color-blocks born foods are usually made by either method:

1. Coat a coagulated patterned food directly by hands with edible pigments in different tints to hence obtain the effect of different color blocks. This method is rather expensive because of hand operation, and moreover, the coating techniques could differ from man to man to result in different quality grades and vision impressions; and

2. Coat first a mould's cavity with edible pigments in different tints directly on a predetermined place, then pour different liquid foods into the mould cavity to thereby obtain the effect of different color blocks. This method usually inevitably mingles the neighboring color blocks with each other by diffusion to therefore spoil the vision impressions.

### SUMMARY OF THE INVENTION

The primary objective of this invention is to provide a mould for patterning foods, such as chocolate or candy sticks, to bear distinct color-blocks without mingling different colors with each other.

In order to realize abovesaid objective, at least a retaining wall is arranged in the mould such that different colors are separated distinctly to hence heighten the integral vision of a pattern food. In practice, a mould cavity, in full conformity with a pattern food to be formed, is formed in a central portion of the mould body, in which at least a retaining wall is arranged for separating a liquid food in different colors. When processing, a liquid food in different colors is first poured into the retaining walls, then another liquid food is in turn poured accordingly for forming a pattern food with distinct color blocks.

The merits of this invention may be summarized as the following:

1. The vision impression of a pattern food could be heightened by applying this invention;

2. The color blocks in different tints wouldn't be mingled with each other by applying this invention; and

3. The labor cost is reducible by applying this invention.

For more detailed information regarding advantages or features of this invention, at least an example of preferred embodiment will be fully described below, with reference to the annexed drawings.

### BRIEF DESCRIPTION OF THE DRAWINGS

The related drawings in connection with the detailed description of this invention to be made later are described briefly as follows, in which:

FIG. 1 is a three-dimensional view of this invention;

FIG. 2 is a cutaway sectional view of an embodiment (I) of this invention;

FIG. 3 is a cutaway sectional view of an embodiment (II) of this invention;

FIG. 4 is a cutaway sectional view of an embodiment (III) of this invention; and

FIG. 5 is a three-dimensional view of a patterned food.

### DETAILED DESCRIPTION OF THE INVENTION

An embodiment is presented below for describing the structure and features of this invention in detail.

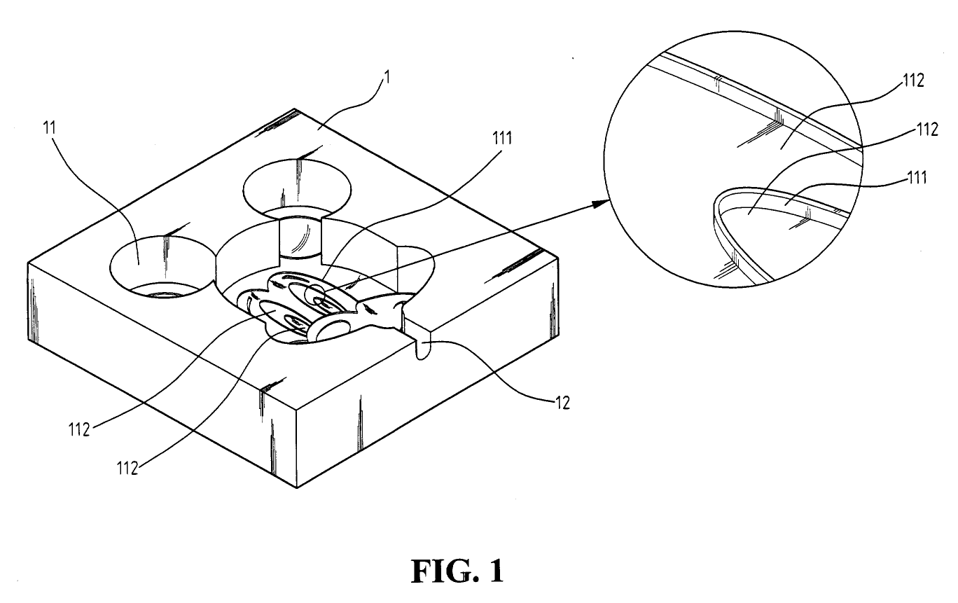

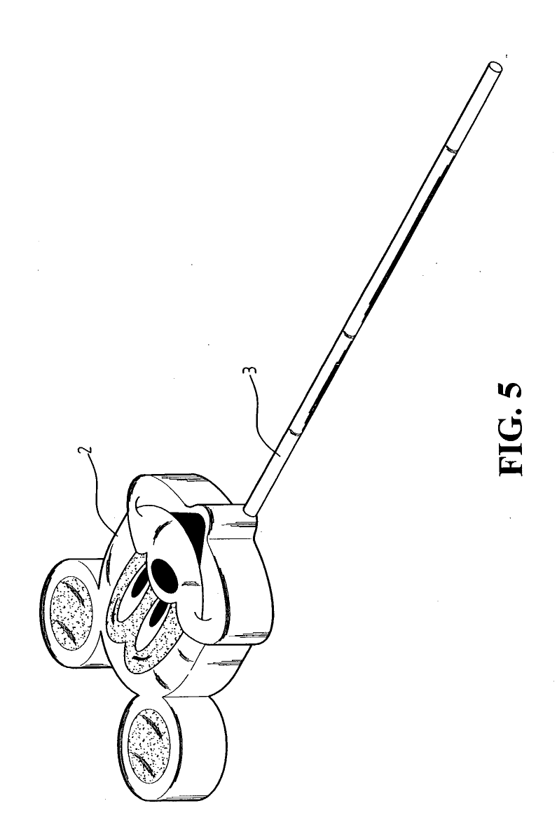

Reference is made to a three-dimensional view of this invention shown in FIG. 1. In FIG. 1, a mould of this invention for patterning foods to bear distinct color-blocks is processed to have a mould cavity (11) formed in the central portion of a mould body (1) for reception of a liquid food to be poured into the mould cavity (11), in which the mould body (1) is generally made of a kind of silicon gel, the inwardly concave mould cavity (11) is shaped thoroughly in conformity with a pattern food (2) to be formed (for example, a chocolate or candy stick shown in FIG. 5). In the mould cavity (11), at least a retaining wall (111) is arranged to form two separate blocks (112) for pouring liquid foods in different tints, such that distinct different color-blocks could be obtained without mingling with each other.

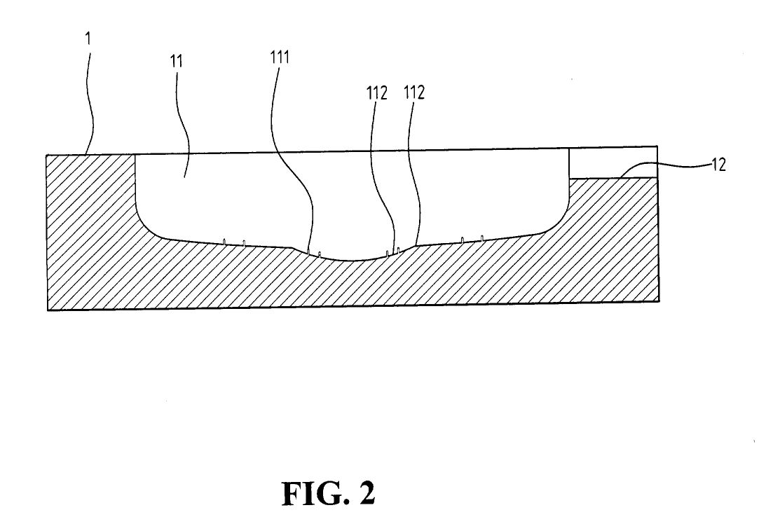

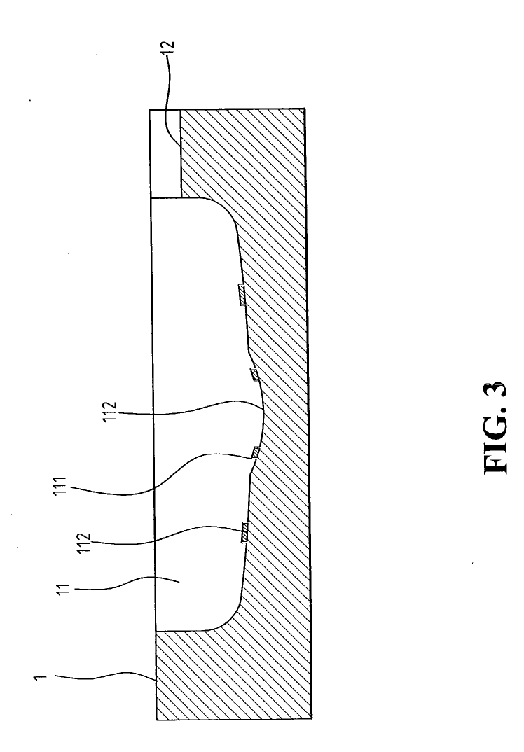

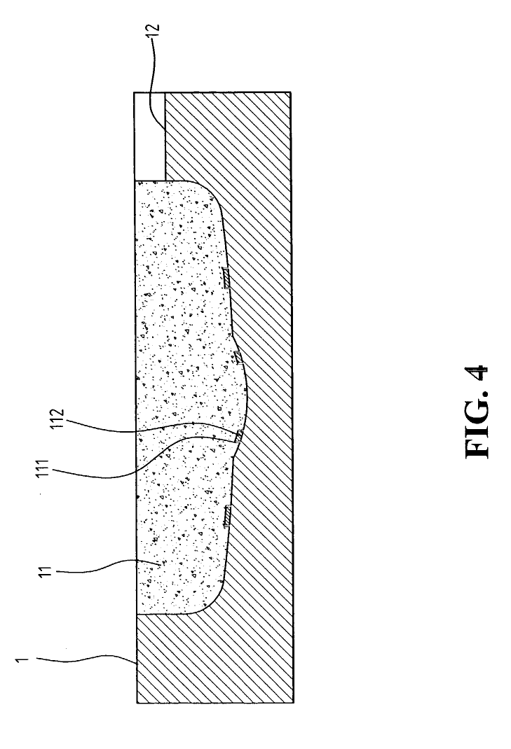

As indicated in FIGS. 2, 3, 4, and 5, including a cutaway sectional view of embodiment (I), (II), and (III), and a three-dimensional view of a pattern food, a mould for patterning foods to bear distinct color-blocks of this invention has a mould cavity (11) formed in a central portion of a mould body (1) for pouring and receiving a liquid food. In an upper edge of the mould body (1), a snapping groove (12) is arranged for combining a handholding stick (3) together with a patterned food (2) during a forming process for a consumer to hold and eat the patterned food.

The inwardly concave mould cavity (11) is shaped thoroughly in conformity with a pattern food (2) to be formed, in which a plurality of strip retaining walls (111) is arranged according to the shape or color design of the pattern food (2) for building several separate blocks (112) in the cavity (11). The production flow path of this invention is to: first, pour or drip a liquid food in different tints into different blocks (112) separated by the strip walls (111) through the inner and/or outer edge thereof; then, pour other liquid food in different tints into the cavity (11) before the previously poured liquid food is thoroughly caked, so that the liquid foods are combined together. In short, by means of the blocks (112) fenced with the retaining walls (111), the liquid foods is prevented from migrating to hence form a pattern food (2) bearing distinct color-blocks.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A mould for patterning foods to bear distinct color-blocks, having a mould cavity arranged in a central portion of a mould body thereof for pouring liquid food, said mould cavity being inwardly concave and in full conformity with the shape of a pattern food to be formed, and said mould being characterized in that at least a retaining wall is arranged in said mould cavity for dividing the same into a plurality of separate blocks.

2. The mould according to claim 1, in which a snapping groove is formed in an upper edge at a proper position of said mould body.

3. The mould according to claim 1, in which said retaining wall is strip-shaped.
